(19) United States
(12) Patent Application Publication
(10) Pub. No.: US 2023/0227063 A1
(43) Pub. Date: Jul. 20, 2023

(54) METHOD AND SYSTEM FOR THE FULLY AUTOMATED GUIDING OF A MOTOR VEHCLE AND MOTOR VEHICLE

(71) Applicant: AUDI AG, Ingolstadt (DE)

(72) Inventors: David Alexander BADOUIN, Ingolstadt (DE); Mohamed Essayed BOUZOURAA, Ingolstadt (DE); Oliver HOFFMANN, Burgebrach (DE); Aykut BAYKARA, Ingolstadt (DE); Denny MARX, Gaimersheim (DE)

(73) Assignee: AUDI AG, Ingolstadt (DE)

(21) Appl. No.: 17/998,239

(22) PCT Filed: Feb. 17, 2021
(86) PCT No.: PCT/EP2021/053817

§ 371 Date: Nov. 8, 2022

(30) Foreign Application Priority Data
May 13, 2020 (DE) 10 2020 112 899.1

(51) Int. Cl. B60W 60/00; G08G 1/0967

(52) U.S. Cl. CPC B60W 60/001; G08G 1/096725; G08G 1/096775; B60W 2555/80; B60W 2556/45; B60W 2552/05

(57) ABSTRACT

The present disclosure relates to a method for the fully automated guidance of a motor vehicle by a vehicle system in a driving situation of at least one driving situation class, wherein the vehicle system has a control device and accesses position data of a position sensor. The method starts with providing a traffic rule database in which traffic rule sets for a plurality of geographic regions are stored in a machine-readable formal language and which can be accessed by the control device, and determining a geographical region currently traveled by the motor vehicle based on the current position data and retrieving a traffic rule set for the currently traveled geographical region from the traffic rule database via the control device. After or upon determination of a trajectory currently to be traveled by the control device, the vehicle system will verify the trajectory for compliance with traffic rules using the retrieved traffic rule set for the geographic region currently traveled by the control device, wherein the trajectory currently to be traveled is adjusted in the event of non-compliance, and guide the motor vehicle based on the trajectory currently to be traveled.

### TECHNICAL FIELD

The present disclosure relates to a method for the fully automated guidance of a motor vehicle by means of a vehicle system in a driving situation of at least one driving situation class, wherein the vehicle system has a control device and accesses position data of a position sensor of the motor vehicle. The present disclosure also relates to a motor vehicle.

### BACKGROUND

Extending the ability of motor vehicles to drive autonomously continues to be an important research topic. Vehicle systems have already been proposed in the prior art for a multiplicity of driving situation classes, which in particular allow the motor vehicle to be guided in a fully automated manner. Examples of such driving situation classes comprise a parking situation class, in particular for automated parking systems, a traffic jam class on a highway (e.g., a so-called traffic jam pilot) and/or a class for highway driving in general (e.g., a so-called highway pilot). Thus far, vehicle systems of this type have always required constant monitoring by the driver, which means that the driver must be “in the loop,” so to speak, and, if in doubt, be able to intervene if a problem occurs. Current research is also largely aimed at vehicle systems with higher autonomy, for example, SAE level 3 and upwards (cf. SAE J 3016 standard).

Highly and fully automated vehicle guidance functions are generally also required to be able to comply with traffic rules, which is sometimes also required by the relevant legislation. However, this results in an extremely high implementation effort, since compliance with traffic rules has to be implemented manually in the corresponding vehicle guidance algorithms, wherein, however, there is the additional problem that traffic rules can differ significantly from region to region, in particular not only from country to country, but sometimes also from administrative unit to administrative unit, for example, from state to state. This leads to a massive effort, wherein a further problem is that of verifying that the resulting vehicle guidance algorithms actually comply with the traffic rules.

### BRIEF DESCRIPTION OF DRAWINGS/FIGURES

FIG. 1 illustrates a flowchart of the method, in accordance with one embodiment.

FIG. 2 illustrates a schematic diagram of a system 1, in accordance with some embodiments.

FIG. 3 illustrates the functional structure of a control device of a vehicle system.

### DETAILED DESCRIPTION

Therefore, the problem addressed by the present disclosure is that of providing a possibility for implementing traffic rules during the fully automated guidance of a motor vehicle, which is improved in comparison.

For solving this problem, the following steps are provided in a method of the type initially mentioned:
providing a traffic rule database in which traffic rule sets for a plurality of geographic regions are stored in a machine-readable formal language and which can be accessed by the control device;
determining a geographical region currently traveled by the motor vehicle based on the current position data and retrieving a traffic rule set for the currently traveled geographical region from the traffic rule database via the control device;
after or upon determination of a trajectory currently to be traveled by the control device, verifying the trajectory for compliance with traffic rules using the retrieved traffic rule set for the geographic region currently traveled by the control device, wherein the trajectory currently to be traveled is adjusted in the event of non-compliance; and
guiding the motor vehicle based on the trajectory currently to be traveled.

It was therefore recognized that traffic rules can be broken down into a specific scheme, which is based on an “if-then-else structure.” This structure can be brought into a machine-readable form by a description in a formal language, for example and preferably a Unified Modeling Language and/or a Systems Modeling Language (UML and/or SysML), so that a control device of a vehicle system for the automated guidance of a motor vehicle can understand this description immediately and use it to verify a determined trajectory currently to be traveled. In other words, a machine-readable formal language is used, which is based in particular on an if-then-else structure in order to provide a traffic rule database which, with particular advantage and preferably centrally for many motor vehicles, provides the appropriate sets of traffic rule sets in a machine-readable form for regions traveled by a motor vehicle to be guided in a fully automated manner.

From position data from a position sensor of the motor vehicle, for example, a sensor of a global navigation satellite system such as a GPS sensor, it can be determined inside the motor vehicle in a known manner in which geographical region the motor vehicle is currently being operated, for example, by comparison with a digital map (“map matching”). The required traffic rule set for the corresponding geographic region can then be retrieved from the traffic rule database and preferably stored locally within the motor vehicle if a central server device is used to provide the traffic rule database. If a future trajectory for the motor vehicle to be traveled is determined, for example, by means of a trajectory determination algorithm, it can be checked for compliance with traffic rules using the traffic rules of the traffic rule set already available in a suitable machine-readable format, so that, in the case of non-compliance with the traffic rules, an adjustment can be made to at least part to the trajectory to be traveled. In this case, the traffic rule database can certainly be specific to a driving situation class to which the vehicle system can be applied. In this way, the number of traffic rules to be formally described in the traffic rule database can be reduced if necessary.

In addition to an embodiment for fundamental vehicle guidance capability, the vehicle system can be, for example, a highway pilot system, a parking system, a traffic jam pilot, an overtaking assistance system, and the like. In general, it can be said that, for example, a highway class and/or a country road class and/or an urban class and/or a parking class and/or an overtaking maneuver class and/or a traffic jam class can be used as driving situation classes. Of course, a multiplicity of further driving situation classes is also conceivable. If the vehicle system is limited to specific driving situation classes, not all traffic rules valid in a geographic region have to be implemented necessarily; instead, traffic rules relevant to the at least one corresponding driving situation class can be selected and stored in the traffic rule database in the machine-readable formal language. If, for example, a scenario addressed by a traffic rule does not occur in driving situations of the driving situation class, the corresponding traffic rule is also not to be included in the traffic rule database specific to this at least one driving situation class. For example, on a highway (highway class), there is no case in which a “right-before-left” rule becomes relevant. This is based on the fact, and it can also be documented, that there are usually no right-before-left intersections on highways. In the example of the highway class, this also applies to the handling of stop signs and the like. In another example, a parking assistant requires no traffic rules related to a high-speed operation on highways.

As already mentioned, a particularly advantageous embodiment provides that the database is stored on a motor vehicle-external, central server device, which is connected to the control device via a communication link, and used for the guidance of a plurality of motor vehicles. Since many motor vehicles usually have communication devices that allow for communication in a mobile network and thus in particular also within the Internet, such access to a central server device by the control device, which then uses the communication device, is possible. In this way, the traffic rule database can be used by a multiplicity of motor vehicles, all of which can retrieve the traffic rules which are expressed in physical restrictions for the trajectory, and take them into account accordingly in the fully automated guidance of the motor vehicle. On the other hand, only one traffic rule database needs to be maintained for all motor vehicles, which can appropriately take into account the problem of frequent law changes. This means that, without constant, in particular manual, revision of the vehicle guidance algorithms in the control device of the vehicle system, specifically the software, the latest traffic rules can be made available to every motor vehicle and applied directly in the motor vehicle.

General advantages of using a machine-readable formal language also comprise the use of a multiplicity of tools developed for the corresponding formal language, which can be used to document, check and monitor the traffic rule database. For example, a connection to specification systems is possible using suitable tools, in particular according to Automotive SPICE. The formal language also allows updates due to changed legislation/case law. Furthermore, it is also possible to map a hierarchy of the different legal norms among themselves, which will be discussed in more detail below.

In this case, rules in the traffic rule database do not necessarily only have to be divided into region-specific traffic rule sets; instead, there can also be a plurality of traffic rule sets for different driving situation classes within individual geographic regions, since, as already explained, different traffic rule sets can be relevant for different driving situations and thus for different areas of application of the vehicle system. Therefore, an advantageous development of the present disclosure provides that a plurality of traffic rule sets, each assigned to a driving situation class, is stored in the traffic rule database for each geographic region, wherein the control device determines a current driving situation class for a current driving situation on which the trajectory currently to be traveled is based and retrieves the traffic rule set assigned to the region currently traveled and the current driving situation class. In this way, only the traffic rules relevant to the driving situation are checked in a specific driving situation, which reduces the computational effort and avoids erroneous physical limitations of the trajectory. In this case, driving situations can also describe specific use cases that have not necessarily been brought about by the motor vehicle concerned. One example is an over-taking maneuver class, since specific traffic rules apply to overtaking maneuvers, while other traffic rules that apply, for example, to the use case of being overtaken are not relevant. It should already be noted at this point that specific use cases can additionally or alternatively also be formally encoded in the traffic rules themselves, as will be explained in more detail below.

It should also be noted at this point that situations are possibly conceivable in which the only possible adjustments to the trajectory can lead to departure from the use case or an exclusion of the use case by the current driving situation. If, for example, the traffic rules associated with an overtaking maneuver (signaling for a specific period of time, not slowing down, or the like) cannot be observed, for example, due to a local speed limit ahead, it is possible that the overtaking maneuver is aborted, which then has to be mapped accordingly in the vehicle guidance function. In a particularly advantageous embodiment, it can also be provided that at least one traffic rule set contains a rule component for changing a driving situation class that is not derived from legal specifications. In other words, a change in the driving situation that is forced by the circumstances and its implementation can also be described by traffic rules, even if there are, at least to some extent, no special legal requirements hereto.

In this context, different configurations are conceivable at the point in time at which a traffic rule set is retrieved from the traffic rule database by the control device. For example, it can be provided that a traffic rule set is retrieved if the region currently traveled and/or the current driving situation class changes. The latter is particularly expedient if the traffic rule sets are also divided according to driving situation classes. Both a change in the driving situation class and a change in the region currently traveled result in a change in the applicable traffic rules, so that a current applicable traffic rule set is retrieved from the traffic rule database by the control device.

It can also be expedient for a traffic rule set to be retrieved after a predetermined update time has elapsed, in particular one day, and/or if update information indicating an update of the traffic rule database is available. As already mentioned, traffic rules can change over time, for example, due to changed legislation and/or case law, so that the traffic rule database is expediently updated regularly, which should also be mapped inside the motor vehicle. For example, a retrieval can in this case take place regularly, for example, daily or weekly, at least once, wherein update information for the traffic rule database, for example, as an update signal, can also be transmitted via the communication link between the traffic rule database and the control device, whereupon the traffic rule sets can also be updated in the motor vehicle.

Specifically, at least one traffic rule of the traffic rule sets can describe a legal use case defining the applicability and obligations, in particular also permissions, for the use case, in particular also additional requirements of the use case. In this way, a modular link can ultimately be made, which is based on the methodology of the use cases. The obligations in the execution of the use case can be understood, for example, such that they describe conditions in order to remain in this use case, wherein a staggering over time is conceivable. Requirements/permissions for a use case can, for example, relate to the basic admissibility of the use case. For example, if the use case is an overtaking maneuver, it assumes that overtaking is allowed; similarly, in the use case “turning,” it must be checked whether the corresponding turn is permissible.

In this case, it can be provided that at least one permanently applicable use case, in particular with regard to a speed limit, and/or a use case brought about by other road users, in particular being overtaken, is used. The example of a speed limit is a permanently applicable use case, since the current maximum speed, which can result as the minimum of different speed limits (described by traffic rules), is to be implemented in principle. In this case, there are different input values specifically describing the driving situation, which can be added in particular to traffic signs or the pure presence on a specific type of road/within city limits. For example, traffic rules leading to specific speed limits can verify whether constant control of the motor vehicle is not ensured, whether visibility is poor due to the weather, whether the stopping distance is greater than the visible road, whether the low beam is activated, whether the traffic situation is unclear, and/or whether the motor vehicle is fitted with tire chains.

However, there are also legal use cases that do not require any conscious action by the motor vehicle concerned. One example of such a use case is that of being overtaken, the conditions of which can all be met by other road users. Nevertheless, this use case also results in obligations, for example, the ban on increasing speed or even reducing speed in order to prevent an accident.

In a further advantageous embodiment, it can be provided that the use of traffic rules of the current, retrieved traffic rule set for the geographical region currently traveled, in particular the verification and adjustment of the trajectory currently to be traveled, in particular comprising a version the traffic rule database from which the traffic rules used were retrieved, is logged in a storage means, in particular in a ring memory, by the control device. In other words, a type of “tachograph” is proposed that automatically also logs every application of the traffic rules, including the version of the traffic rule database from which the traffic rules used originate. In this way, compliance with the traffic rules by the vehicle system, specifically the vehicle guidance function, can be superbly traced, for example, in the event of an accident. Since such information is required in particular in the case of special incidents, it can be expedient to use a ring memory or a ring buffer as a storage means, i.e., storing a specific number of logging data sets according to the FIFO principle. In this way, a specific number n of the most recent applications of traffic rules are available in the storage means, so that, in the case of special events, in particular accidents, compliance with the traffic rules by the motor vehicle is traceable. This means that the influence of the traffic rules on the trajectory to be physically implemented by the motor vehicle can be traced.

In this context, it is also particularly advantageous if changes, in particular updates, for example, in the manner of a change log, are logged with respect to the traffic rule database. In this way, or in an alternative way, it is also expedient if an old version of the traffic rule database can be restored. In this context, it should be noted that a change in the traffic rule database can also comprise a structural change, for example, storing equal parts of local traffic rules, possibly generalized and summarized, wherein local specifics, and/or a parameterization, can be mapped over additional specific rules, in particular also traffic rules.

In this context, it should also be pointed out that different geographic regions can also only differ in terms of parameterization, for example, different maximum speeds, different distance rules, and the like. It is therefore conceivable to store at least parts of the traffic rules as a common data object and, in order to generate the traffic rule set for a geographic region, to subject this data object to suitable parameterization, which can also be mapped in the traffic rule database or in the course of accessing.

In a further advantageous embodiment, it can be provided that the traffic rule database is automatically checked for conflict freedom before it is made available. Especially when using already known, in particular standardized, machine-readable formal languages, for example, SysML and/or UML, tools or general software means are already available to check for conflict freedom, which is particularly important with regard to traffic rules. By using the machine-readable formal language and the resulting formal representation, a machine verifiability of conflict freedom is possible. In this way, conflicting requirements can be found and prevented.

In an expedient development of the present disclosure, it can be provided that the traffic rule sets comprise at least one hierarchy such that at least one traffic rule is assigned at least one condition that overrides said traffic rule and/or traffic rules are assigned priorities, and/or at least one driving situation class containing critical driving situations, in particular collision situations, is defined, which is assigned a restricted traffic rule set in the traffic rule database, and/or the control device, upon detecting a critical driving situation, suspends at least partially the check against the retrieved traffic rule data set of the region currently traveled.

Many pieces of legislation have a type of hierarchy in the sense that specific traffic rules can be disregarded and/or changed in special cases. In one example, a solid line can be crossed if the endangerment of human life is thus avoided. In less preferred embodiments, a formal description of such a hierarchy is conceivable for such cases. In particular, at least some of the traffic rules can be assigned at least one condition that overrides said traffic rules or a prioritization can be created, wherein ultimately not necessarily legally sound traffic rules are implemented that have a higher priority, for example, that a pedestrian must be avoided, in order to reflect the hierarchy provided by legislation.

In more preferred embodiments, it can also be provided that a special, in particular restricted, traffic rule set for critical driving situations, for example, collision situations, is defined, which is then assigned to a corresponding driving situation class. In other words, this means that, for example, collision avoidance is ensured by a separate entity that only becomes active in the event of an actual case of danger. This traffic rule set does not have a complete implementation of the legal basis, so that, for example, a solid line can certainly be crossed if safety aspects are taken into account. Finally, in this respect, one advantageous embodiment is also conceivable in which the implementation of such a loss of validity of traffic rules in special driving situations is implemented by the control device itself, for example, in a verification algorithm that implements the verification. For example, if a critical driving situation is detected, the control device can at least partially suspend the verification at least temporarily, for example, for the duration of the critical driving situation. This variant would have the advantage that the design and management of the traffic rule database is simplified, but at least in the case of more complex hierarchies, for example, when different critical driving situations, in particular different driving situation classes of this type, need to be differentiated, greater effort is required on the part of the motor vehicle.

Within the scope of the present disclosure, different advantageous architectures are conceivable in order to concretely implement the verification and adjustment of the trajectory currently to be traveled. For example, in a first variant, it can be provided that the control device has a trajectory determination unit that implements a trajectory determination algorithm to determine the trajectory to be verified and currently to be traveled, and a verification unit that implements a verification algorithm to verify the determined trajectory currently to be traveled. In this case, the trajectory can first be determined and then verified, since it can be assumed that traffic rule violations are rather rare in normal trajectory planning. This is the case in particular if at least some of the traffic rules, in particular those for permanently existing use cases, are already included in the determination as boundary conditions to be taken into account and thus to be verified.

In such a subsequent verification, it can be provided in a first architecture that the trajectory is returned with at least one piece of adjustment information to the trajectory determination unit performing the adjustment if non-compliance is determined. This means that there is ultimately a feedback loop for trajectory planning, which provides additional information as input, in particular comprising the traffic rule violated and/or requirements for complying with the traffic rule. In this way, an already existing trajectory determination algorithm used for trajectory planning is further utilized, so that no additional complex program code is required, even though iterative improvements may be necessary.

An alternative, other design of the architecture provides, again with the presence of the trajectory determination unit and the verification unit, that an adjustment algorithm of the verification unit is used to adjust the trajectory when non-compliance is determined. This means that, in this case, the verification unit, which can also be referred to as a traffic rule monitor, has its own type of trajectory planning that was developed accordingly in order to establish traffic rule compliance in a targeted and less complex manner.

As these architectural forms show, an adjustment unit for adjusting the trajectory currently to be traveled can thus be designed to be at least partially integrated with other functional units.

As already indicated, it is also conceivable to already apply at least some of the traffic rules of the current traffic rule set during the determination of the trajectory currently to be traveled, in particular as boundary conditions. The verification unit is then at least partially integrated into the trajectory determination unit. This can also be entirely the case if all traffic rules, in particular as boundary conditions, are already included in the trajectory planning. The trajectory currently to be traveled is then adjusted accordingly during its determination if a boundary condition is violated. However, for good measure, a verification after the determination can still be carried out even in such a case. In these examples, the verification unit can thus also be at least partially integrated with a further functional unit, in particular the trajectory determination unit.

Generally speaking, the verification algorithm of the verification unit is already designed particularly advantageously such that it can itself process the machine-readable formal language and can therefore use a retrieved traffic rule set directly, be it, for example, as a boundary condition during the determination and/or as a compliance condition after the determination. However, embodiments are also conceivable in which the control device generates a program code through compilation from the current traffic rule set for the region currently traveled. Such interpreters, which can interpret machine-readable formal languages completely automatically and embed them correctly in a program code to be compiled, so that a compiled software means is created which uses the traffic rule set, have already been proposed in the prior art for other purposes and can also be used within the scope of the present disclosure. The special advantage of integration into a compiled software means, which, for example, subsequently implements the verification algorithm, is that there is no increase in computing time due to an interpretation of the traffic rule set made at runtime in the machine-readable formal language when verifying trajectories currently to be traveled, which takes place quite frequently. In other words, the interpretation of the expressions of the machine-readable formal language is therefore only necessary at a point in time when it has been shown that the motor vehicle usually remains within the validity region of a traffic rule set for a specific period, both in terms of the current geographic region and the driving situation, for which said period would possibly be shorter, so that during this period, a multiplicity of verifications of current trajectories to be traveled becomes necessary and a corresponding pre-compilation can be extremely expedient. Moreover, automating the compilation is advantageous in that an error-prone manual work step is avoided.

It should also be noted at this point that procedures for trajectory planning, i.e., for determining the trajectory currently to be traveled, have already been proposed in a variety of ways in the prior art. In this case, input data comprising the current environment of the motor vehicle and/or information about the motor vehicle itself, which can be referred to as ego data and comprise, for example, its operating state, are usually used. In this case, environmental data can comprise sensor data from environmental sensors of the motor vehicle, but also further environmental information, for example, information that can be determined from a digital map present in the motor vehicle, for example, in a navigation system. In vehicle systems that are designed for the fully automated guidance of motor vehicles, it is usually provided that a situation interpretation is carried out prior to the trajectory planning, which can also be done within the scope of the present disclosure. For this purpose, for example, raw sensor data are processed in order to generate a data object, for example, as or comprising an environment map, that describes the current driving situation and can be used as situation data as the basis for trajectory planning. In particular, a driving situation class can already be assigned to the driving situation as part of the situation interpretation.

As part of the situation interpretation and/or otherwise determined situation data which describe the current driving situation of the motor vehicle and in particular can also comprise sensor data, for example, raw sensor data, can also form input data for the evaluation of traffic rules. This applies in particular to determining whether a legal use case for a traffic rule is present, as has already been described above. For example, there are traffic rules that apply when the motor vehicle exceeds a certain speed, there are traffic rules that relate to poor visibility, traffic rules that relate to specific additional equipment of the motor vehicle, and the like. The presence of these aspects usually results from the situation data, in particular from sensor data of the situation data, which thus allow for the determination of the presence of the use case for the corresponding traffic rule. This means generally that at least some of the traffic rules in the traffic rule database evaluate situation data, in particular comprising sensor data, describing the current driving situation of the motor vehicle. In this way, it can ultimately be said that both the trajectory planning and the verification of traffic rule compliance include measurement data whose processing has a direct control-related and thus physical effect, namely the ultimately resulting trajectory traveled by the motor vehicle.

It must also be noted that the term “trajectory” is to be understood broadly within the scope of the present disclosure. It does not necessarily have to describe only the temporal and spatial sequence of a future movement of the motor vehicle, but can also comprise other measures, such as the activation of driving direction indicators, preconditioning measures for other vehicle systems and the like that are assigned to the temporal and spatial sequence of the trajectory.

In addition to the method, an aspect of the invention also relates to a motor vehicle having a vehicle system for the fully automated guidance of the motor vehicle in a driving situation of at least one driving situation class, wherein the vehicle system has a control device which is designed to access position data from a position sensor of the motor vehicle and a traffic rule database in which traffic rule sets for a plurality of geographic regions are stored in a machine-readable formal language, wherein the control device has:
a retrieval unit for determining a geographical region currently traveled by the motor vehicle on the basis of the current position data and for retrieving a traffic rule set for the geographical region currently traveled from the traffic rule database,
a trajectory determination unit for determining a trajectory currently to be traveled,
a verification unit for verifying the trajectory for traffic rule compliance using the traffic rule set retrieved for the geographic region currently traveled after or during the determination, wherein the trajectory currently to be traveled is adjusted in the event of non-compliance, and
a guidance unit for guiding the motor vehicle based on the trajectory currently to be traveled.

All statements relating to the method according to the present disclosure can be transferred to the motor vehicle according to the present disclosure, with which the above-mentioned advantages can thus also be obtained. In particular, it is therefore also possible in the motor vehicle according to some embodiments to determine non-compliance of a trajectory with regard to traffic rules and to adjust the trajectory in the event of non-compliance such that compliance is established. In this context, as in the case of the method according to the present disclosure, in particular non-compliance information determined during verification is used as adjustment information for adjusting the trajectory. Non-compliance information describes in particular which traffic rule is violated and in what way, which allows for easy adjustment. As described, functional units can also be designed to be at least partially integrated into one another.

Finally, the present disclosure also relates to a system for the fully automated guidance of a motor vehicle according to the present disclosure in a driving situation of at least one driving situation class, having the vehicle system and a central server device which is connected to the control device via a communication link, wherein the server device is designed to provide the traffic rule database. The system according to the some embodiments is therefore designed to carry out the method according to the some embodiments, so that all statements relating to the method according to the present disclosure and the motor vehicle according to the present disclosure naturally continue to apply analogously. Further advantages and details of the present disclosure can be found in the embodiments described below and with reference to the drawings:

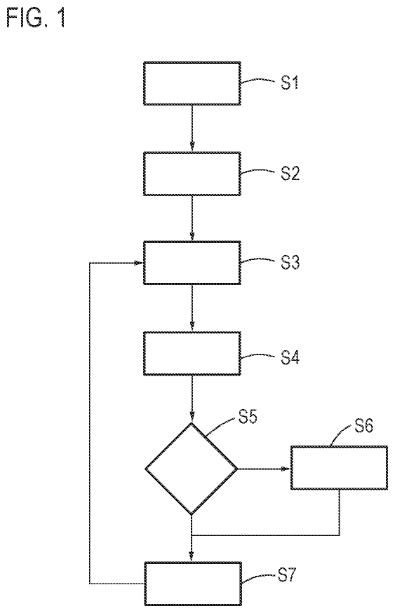

FIG. 1 illustrates a flowchart of the method, in accordance with one embodiment. This embodiment is used to establish compliance with traffic rules for a fully automated operation of a motor vehicle, i.e., a highly and/or fully automated vehicle guidance function. For this purpose, a traffic rule database is first provided in a step S1.

The traffic rule database contains traffic rule sets for different geographic regions in which different traffic rules apply, said traffic rule sets containing at least the traffic rules relevant to the vehicle guidance function, formulated in a machine-readable formal language, for example, SysML or UML. After considering vehicle guidance functions that can be used in different driving situations that can be assigned to different driving situation classes, the traffic control database contains a plurality of traffic rule sets for each geographic region, each of which is assigned to a driving situation class. Driving situation classes combine driving situations for which specific traffic rules of the total volume of traffic rule sets apply, but other traffic rules do not have to be observed. Depending on the area of application of the vehicle guidance functions to which the traffic rule database is directed, driving situation classes can additionally be defined in a broader or narrower manner. For example, a division into a highway class, a country road class, and an urban class is conceivable, wherein other driving situation classes can comprise, for example, an overtaking maneuver class, a being overtaken class, an intersection situation class, a traffic jam class, and the like.

The database provided in step S1 can in principle be compiled manually, but it is preferable to generate said database automatically on the basis of a further database, for example, a requirement database which can be present, for example, as a tabular document that can be at least partially generated manually. For example, it is conceivable to automatically generate traffic rules in SysML from a table file.

Different software tools already proposed in the prior art for other purposes can be applied to the traffic rule database, for example, an interface to a specification system can be created in order to create documentation, a check can be carried out for any conflicts that may be present, and the like. If there are conflicts present, for example, the underlying requirement database or the traffic rule database itself can be adjusted manually in order to rule out the conflict, since traffic rules should not be in conflict with one another. With regard to traceability, software tools can also be applied to the traffic rule database, for example, to verify whether the components of the database represent a benefit for the overall function or to verify that an overall function is fulfilled by the sum of its derived component requirements. Furthermore, it is expedient for the traffic rule database if the formal representation of the traffic rules can be linked to the requirements for development in order to be able to map traceability, which is already possible with SysML elements with tool support.

The traffic rule database can be updated, wherein the most current version is expediently always provided in step S1. This is due to the fact that traffic rules, be it through legislation or case law, can change over time. Within the scope of this embodiment, the status of the traffic rule database is logged, as are the changes made, for example, in a change log. This means that old versions of the traffic rule database can be restored.

In this case, it is expedient to design the traffic rule database as effectively as possible. For example, it can be assumed that traffic rules are basically the same structurally in different geographic regions, but are parameterized differently, for example, in the case of maximum speeds. This means that, for at least some of the traffic rules and/or geographic regions, a set of basic rules can be used which is parameterized in a region-specific manner in order to at least partially generate a traffic rule set for the region.

In the present case, a traffic rule can preferably be mapped by at least two elements. One of these elements describes the legal use case, i.e., it specifies in particular conditions which indicate that the legal use case is present and therefore the traffic rule is at all applicable. A further element can describe obligations arising from the traffic rule when carrying out the use case, for example, an overtaking maneuver or a turning maneuver. As a further element, requirements of the use case or permissions can be mapped, for example, in the case of an overtaking process as to whether overtaking is allowed at all.

It should also be noted in this context that, in particular, a combination of (more broadly defined) driving situation classes with the traffic rules describing such use cases is expedient. This results in a structuring that, for example, initially reflects a type of “setting” with the driving situation class, for example, a highway operation, in which different use cases can occur, for example, following a vehicle, overtaking maneuvers, and the like, which can be identified on the basis of certain requirements for the presence of the use case. In this case, for example, different conditions can be combined into requirements for the presence of a use case in the traffic rule database. Conditions themselves do not yet represent traffic rules which only arise through the combination of different conditions and the linking with commands and prohibitions (obligations). The conditions can expediently be grouped into requirements or super conditions in the machine-readable formal language, wherein it should be possible for the grouped conditions to be assigned to specific logical and technical system parts/components.

The traffic rule database can also map hierarchies in the sense that specific traffic rules are overridden if certain conditions are met or are replaced by another traffic rule. It is in this case fundamentally conceivable to assign traffic rules to at least one condition that overrides them, but since such invalidity conditions usually presuppose the presence of danger, it is preferred to either define at least one driving situation class containing critical driving situations, for example, collision situations, to which a restricted traffic rule set in the traffic rule database is assigned, or to implement this hierarchy in the respective control devices of the vehicle systems, which, for example, upon detection of a critical driving situation, at least partially suspend the check against a retrieved traffic rule data set of the geographic region currently traveled. For example, if there is a risk of an accident or even to life and limb of another person, it can be permissible to drive over solid lines, to exceed maximum speeds for a short time, and the like.

In this case, the traffic rule database is stored on a motor vehicle-external central server device and connected or connectable to the control devices of vehicle systems of different motor vehicles via a communication link. In this way, the traffic rule database can be used in the guidance of a multiplicity of motor vehicles, for which a central update can then be made with regard to the traffic rules. In this case, it is provided that, whenever the traffic rule database is updated, corresponding update information, specifically, for example, an update signal, is transmitted to the control devices of vehicle systems that communicate with the traffic rule database and realize corresponding vehicle guidance functions, so that the corresponding control device can retrieve updated traffic rule sets.

This retrieval of a traffic rule set currently to be used takes place in step S2. In addition to the retrievability mentioned, it is provided in any case that, whenever the traffic rule database has been updated, a new, current traffic rule set is retrieved when the driving situation class and/or the geographical region change, which means that a different traffic rule set is to be used anyway. If, for example, a motor vehicle crosses a national border, said crossing can be determined on the basis of the position data from a position sensor of the motor vehicle, for example, a GPS sensor, so that the new geographical region currently traveled can also be determined, which is done by the control device inside the respective motor vehicle. The appropriate traffic rule set can thus be retrieved in a targeted manner from the traffic rule database in step S2, possibly taking the driving situation class into account.

It should be noted that step S2 and the steps discussed below can occur in a nested manner during the fully automated guidance of a motor vehicle by the vehicle system, for example, if the geographic region changes during the fully automated guidance of the motor vehicle, if the driving situation class changes, and/or if an update of the traffic rule database occurs.

Within the scope of the present disclosure, it can be preferred that the retrieved traffic rule set is used in the control device in order to generate a new program code, in particular by compiling, which directly applies the current traffic rules of the traffic rule set retrieved a moment ago. As a result, an interpreter, which embeds the machine-readable formal language in a software medium, only has to be used at the time of compilation and not every time the traffic rules are applied.

A case is discussed below in which a trajectory to be traveled is first determined and subsequently verified for compliance with the traffic rules in order to be able to adjust said trajectory if necessary. Embodiments of the present disclosure are also conceivable in which at least some of the traffic rules of the traffic rule set are directly included in the determination of the trajectory, for example, a maximum speed as a boundary condition for the trajectory planning. This means that a combination of the use of the traffic rules of the traffic rule set is also conceivable, so that a part of the traffic rules is directly included in the trajectory planning, and is therefore verified as a boundary condition when the trajectory planning is determined, and another part is then used to verify the (completely determined) trajectory.

Steps S3 to S7 represent measures to implement the fully automated operation of the motor vehicle. In this case, the key part is the trajectory planning which determines which control commands are generated by the vehicle system that executes the vehicle guidance function in order to implement the trajectory currently to be traveled, which is ultimately constantly updated based on current information.

First, in step S3, a situation interpretation (situation analysis) takes place which uses different input data comprising sensor data from environmental sensors and other sensors of the motor vehicle, further environmental information, and ego data about the motor vehicle itself, in particular its current operating status. In this case, an environment map can be created, for example, wherein the situation data describing the current driving situation, which are obtained as a result of step S3 and usually also comprise further information, can, in particular, also describe a driving situation class and the geographical region currently traveled. Furthermore, sensor data themselves can continue to serve as situation data.

The situation data are used in step S4 in order to determine a trajectory to be traveled for the further fully automated operation of the motor vehicle in a manner fundamentally known in the prior art. This can be done, for example, using a trajectory determination algorithm.

In a step S5, the retrieved traffic rule set currently to be used is then used in order to verify the determined trajectory currently to be traveled for compliance with the traffic rules. If it is determined that at least one traffic rule is not observed, a corresponding adjustment of the trajectory currently to be traveled is carried out in a step S6, in particular using adjustment information describing the non-observed traffic rule and the type of non-compliance, in order to establish traffic rule compliance.

In this case, two basic architectures are conceivable for an at least partial verification after the determination. In a first architecture, the trajectory to be adjusted can be returned together with the adjustment information as additional information to the trajectory determination algorithm which carries out an adjustment taking this additional information into account. However, it is also possible to use a dedicated adjustment algorithm in order to establish traffic rule compliance in step S6. In both cases, it can be provided that a new verification takes place in step S5 if the adjustment cannot rule out a violation of another traffic rule.

The result of each verification in step S5 and each use of a traffic rule to adjust the trajectory currently to be traveled is stored in a storage means designed as a ring memory in order to document the application of the traffic rule and its influence on the control of the motor vehicle, for example, when an accident or another situation occurs that may make documentation necessary. The version used, i.e., the status, of the traffic rule database from which the traffic rule set was retrieved in step S2 is also stored.

In a step S7, the possibly adjusted trajectory currently to be traveled is then used to guide the motor vehicle before returning to step S3 in the next time step for updating, to be carried out regularly, the trajectory currently to be traveled.

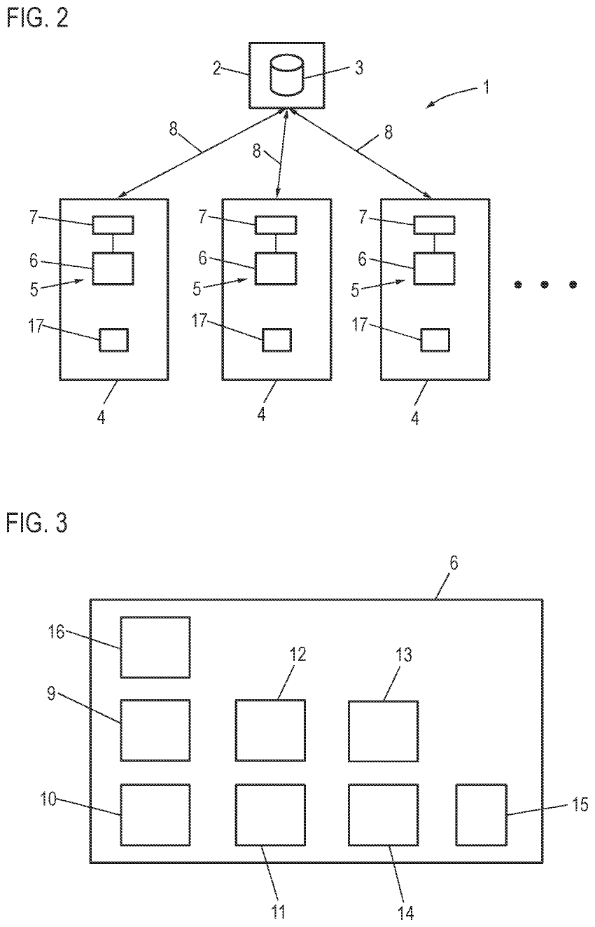

FIG. 2 illustrates a schematic diagram of a system 1 according to some embodiments, with which the method according to some embodiments can be carried out. The system 1 has the central server device 2 on which the traffic rule database 3 is stored and made available. Updating measures and the like also take place in the server device in a central manner. As described, the traffic rule database 3 is used by a plurality of motor vehicles 4 for their fully automated guidance, wherein each of these motor vehicles 4 has a vehicle system 5 for the fully automated guidance of the motor vehicle 4, which therefore performs the highly or fully automated vehicle guidance function using a control device 6 for this purpose. The control device 6 can set up the described communication link 8 to the central server device 2 via a communication device 7 of the respective motor vehicle 4 and thus retrieve traffic rule sets from the traffic rule database 3. Furthermore, the control device 6 of each of the motor vehicles 4 is designed to carry out steps S2 to S7. Consequently, the motor vehicles 4 are motor vehicles according to the present disclosure.

It should be noted in this context that the motor vehicles 4 naturally also comprise further components integrated into the fully automated guidance of the respective motor vehicle 4, for example, environmental sensors, further vehicle systems, intrinsic sensors, and the like for input data of the situation interpretation in step S3, and a multiplicity of controllable actuators, in particular comprising the drive and braking means as well as steering means. It should be pointed out that the input data for the situation interpretation and/or situation data resulting from the situation interpretation can, of course, at least partially also represent input data for verifying whether use cases for traffic rules are present. It should also be pointed out that non-compliance of the current state can be determined in particular if the current operating state of the motor vehicle or the current driving situation as the starting point of the trajectory currently to be traveled is verified for compliance with the traffic rules; said current state can also be treated by not necessarily legally sound traffic rules contained in the traffic rule database 3 in order to again depart from a use case or a driving situation class, for example.

According to FIG. 3, the control device 6 therefore initially comprises a situation interpretation unit 16 which generates the situation data according to step S3, wherein position data from the position sensor 17, herein a GPS sensor, and digital map material from a navigation system of the motor vehicle (not shown in detail) can also already be used to determine the geographic region currently traveled. In this case, the geographic region is determined by a retrieval unit 9 from the corresponding situation data. Otherwise, the retrieval unit 9 itself can also be designed to evaluate position data and, in particular, digital map material of the navigation system. The retrieval unit 9 is also designed to retrieve a traffic rule set for the geographic region currently traveled from the traffic rule database 3, in particular taking into account a driving situation class resulting, for example, from the situation data of the situation interpretation unit 7. A traffic rule set is retrieved from the traffic rule database 3 if a retrieval condition is met, as described above, for example, if the geographic region and/or the driving situation class changes and/or if update information is available. In other words, the retrieval unit is designed to carry out step S2.

A trajectory determination unit 10 is designed for trajectory planning (cf. step S4), while a verification unit 11 is designed to verify compliance with the traffic rules of the traffic rule set, step S5. The trajectory determination unit 10 realizes a trajectory determination algorithm, and the verification unit 11 realizes a verification algorithm which, in embodiments, can have emerged from the described compilation using the traffic rule set. In the variant in which the trajectory currently to be traveled is to be adjusted in the verification unit 11 itself in the event of non-compliance, the verification unit 11 can also realize the corresponding adjustment algorithm.

In the event of non-compliance, an adjustment unit 12, which can, for example, implement an adjustment algorithm, is used to establish compliance with the traffic rule set, cf. step S6.

It should be noted at this point that, depending on the specific configuration, the trajectory determination unit 10, the verification unit 11, and the adjustment unit 12 can also be provided at least partially integrated with one another, for example, if verification aspects are implemented by boundary conditions during the trajectory determination and/or if the adjustment is carried out by the trajectory determination algorithm itself, so that the adjustment unit 12 ultimately only has to provide the suitable additional information (adjustment information) to the trajectory determination unit 10 or to switch it to a special mode.

Finally, in a guidance unit 13, the possibly adjusted, trajectory currently traveled is used according to step S7 to guide the motor vehicle 4, as is known in principle.

In the present case, the control device 6 also has a logging unit 14 which, as described, logs the use of the traffic rules of the traffic rule set by entries in a storage means 15 implemented as a ring memory.

1-14. (canceled)

15. A method, comprising:
providing a traffic rule database that stores traffic rule sets for a plurality of geographic regions in a machine-readable formal language and that can be accessed by a control device;
determining a geographical region currently traveled by a motor vehicle based on current position data;
retrieving, from the traffic rule sets via the control device, a retrieved traffic rule set for the currently traveled geographical region from the traffic rule database;
determining, by the control device, a trajectory currently to be traveled;
verifying, by the control device, the trajectory for compliance with traffic rules using the retrieved traffic rule set for the geographic region currently traveled;
adjusting the trajectory currently to be traveled in an event of non-compliance; and
guiding the motor vehicle based on the trajectory currently to be traveled,
wherein the method is performed by a vehicle system for a fully automated guidance of a motor vehicle in a driving situation of at least one driving situation class, and
wherein the vehicle system comprises the control device and accesses position data of a position sensor of the motor vehicle.

16. The method of claim 15, wherein the machine-readable formal language is a Unified Modeling Language and/or a Systems Modeling Language.

17. The method of claim 15,
wherein the traffic rule database is stored on a central server device that is external to the motor vehicle, and
wherein the central server device is connected to the control device via a communication link and is used for the guidance of a plurality of motor vehicles.

18. The method of claim 15,
wherein retrieving a retrieved traffic rule set includes the control device determining a current driving situation class for a current driving situation based on the trajectory currently to be traveled and retrieving the retrieved traffic rule set assigned to the region currently traveled and the current driving situation class, and
wherein the retrieved traffic rule set is assigned to a driving situation class and is stored in the traffic rule database for a geographic region.

19. The method of claim 15, wherein retrieving a retrieved traffic rule set takes place if at least one of the following happens:
the region currently traveled changes;
the current driving situation class changes;
a predetermined update time has elapsed, wherein the predetermined update time is one day; or
update information indicating an update of the traffic rule database is available.

20. The method of claim 15, wherein the traffic rule sets includes at least one traffic rule that describes a legal use case defining the applicability, obligations, permissions, and additional requirements for the use case.

21. The method of claim 20, wherein the legal use case includes at least one of a permanently applicable use case or a use case brought about by other road users,
wherein the permanently applicable use case relates to a speed limit, and
wherein the use case brought about by other road users includes being overtaken.

22. The method of claim 15,
wherein the control device logs a use of the retrieved traffic rule set for the geographical region currently traveled in a ring memory,
wherein the use of the retrieved traffic rule set includes the verification and adjustment of the trajectory currently to be traveled, and
wherein the use of the retrieved traffic rule set includes a version of the traffic rule database that the traffic rules used were retrieved from.

23. The method of claim 15, wherein the method further comprises:
automatically checking for conflict freedom before providing the traffic rule database.

24. The method of claim 15,
wherein the control device, upon detecting a critical driving situation, suspends at least partially the check against the retrieved traffic rule data set of the region currently traveled, or
wherein the traffic rule sets comprise at least one of the following:
a hierarchy that at least one traffic rule is assigned at least one condition that overrides said traffic rule;
traffic rules assigned with priorities; or
a defined driving situation class containing critical driving situations, wherein the critical driving situations include a collision situation, that is assigned a restricted traffic rule set in the traffic rule database.

25. The method of claim 15, wherein in an event of non-compliance, the method further comprises:
either returning the trajectory with at least one piece of adjustment information to the trajectory determination unit performing the adjustment,
or adjusting the trajectory using an adjustment algorithm of a verification unit,
wherein the control device comprises:
a trajectory determination unit that implements a trajectory determination algorithm to determine the trajectory to be verified and currently to be traveled; and
the verification unit that implements a verification algorithm to verify the determined trajectory currently to be traveled.

26. The method of claim 15, wherein the method further comprises:
generating, by the control device, a program code through compilation from the current traffic rule set for the region currently traveled.

27. A motor vehicle comprising:
a vehicle system configured to provide a fully automated guidance of the motor vehicle in a driving situation of at least one driving situation class, the vehicle system comprising:
a control device configured to access position data from a position sensor of the motor vehicle and a traffic rule database in which traffic rule sets for a plurality of geographic regions are stored in a machine-readable formal language, the control device comprising:
a retrieval unit configured to determine a geographical region currently traveled by the motor vehicle on the basis of the current position data and for retrieving a traffic rule set for the geographical region currently traveled from the traffic rule database;
a trajectory determination unit configured to determine a trajectory currently to be traveled;
a verification unit configured to verify the trajectory for traffic rule compliance using the traffic rule set retrieved for the geographic region currently traveled after or during the determination, wherein the trajectory currently to be traveled is adjusted in the event of non-compliance; and
a guidance unit configured to guide the motor vehicle based on the trajectory currently to be traveled.

28. A system configured to provide a fully automated guidance of the motor vehicle in a driving situation of at least one driving situation class, the system comprising:
a vehicle system; and
a central server device coupled to a control device via a communication link, the central server device configured to provide a traffic rule database,
wherein the vehicle system comprises:
the control device configured to access position data from a position sensor of the motor vehicle and a traffic rule database in which traffic rule sets for a plurality of geographic regions are stored in a machine-readable formal language, the control device comprising:
a retrieval unit configured to determine a geographical region currently traveled by the motor vehicle on the basis of the current position data and for retrieving a traffic rule set for the geographical region currently traveled from the traffic rule database;
a trajectory determination unit configured to determine a trajectory currently to be traveled;
a verification unit configured to verify the trajectory for traffic rule compliance using the traffic rule set retrieved for the geographic region currently traveled after or during the determination, wherein the trajectory currently to be traveled is adjusted in the event of non-compliance; and
a guidance unit configured to guide the motor vehicle based on the trajectory currently to be traveled.
